(19) United States
(12) Patent Application Publication
(10) Pub. No.: US 2008/0065693 A1
(43) Pub. Date: Mar. 13, 2008

(54) PRESENTING AND LINKING SEGMENTS OF TAGGED MEDIA FILES IN A MEDIA SERVICES NETWORK

(75) Inventor: Dale Malik, Atlanta, GA (US)

Correspondence Address: WITHERS & KEYS FOR BELL SOUTH, P. O. BOX 71355, MARIETTA, GA, 30007-1355, US

(73) Assignee: BellSouth Intellectual Property Corporation

(21) Appl. No.: 11/530,674

(22) Filed: Sep. 11, 2006

(51) Int. Cl. G06F 17/00

(52) U.S. Cl. 707/104.1

(57) ABSTRACT

Media segments are extracted from tagged media program files which may be associated with broadcast media programs in a media services network. Each media segment may be associated with a portion of a broadcast media program which is associated with a media attribute, as a character or storyline in a television series. Media segments based on the same media attribute may be linked and utilized to create a customized media program for playback on a media player.

### BACKGROUND

With the advent of modern media services networks, such as cable, satellite and home media systems, media viewers have grown accustomed to receiving a variety of media programming, such as television programs, from numerous broadcasting sources via cable, satellite, personal computer or the Internet. Many of the media programs available from these networks are episodic in nature and include storylines and characters which may not be broadcast in consecutive episodes. For example, a storyline for a television series may start in the first episode and pickup again in the twelfth episode. Furthermore, a particular storyline or character introduced in one episode may not be seen again until a subsequent season of a television series or may be picked up in an episode of a different television series (e.g., a crossover between two different television series).

As a result of the non-linear nature of current media programming, viewers often find it difficult to track favorite characters or storylines during the middle of a season or if one or more episodes are missed. While media broadcasting sources are currently able to provide information about individual episodes for viewing via program information embedded in a media broadcast program (such program information may be viewed utilizing on-screen program guide, for example), this information is typically limited to a single episode summary along with a listing of primary characters in a series. Thus, viewers are unable to determine from the summary if a particular episode of a television series is related to one or more other episodes having a common storyline or character. As a result, viewers seeking episodes of a television series limited to a particular storyline or characters must manually piece the episodes together by looking at transcripts to determine storylines and identify characters or purchase all of the episodes of a television series on recordable media and manually view them to determine specific storylines and/or characters of interest.

It is with respect to these considerations and others that the various embodiments of the present invention have been made.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Various embodiments solve the above and other problems by presenting and linking segments of tagged media program files in a media services network. Media segments are extracted from tagged media program files which may be associated with broadcast media programs in a media services network. Each media segment may be associated with a portion of a broadcast media program which is associated with a media attribute, as a character or storyline in a television series. Media segments based on the same media attribute may be linked, played back on a media player, and utilized to create a customized media program for playback on a media player.

According to one exemplary embodiment, a request is received for one or more media program segments based on a media attribute appearing in one or more media programs. A tagged media file is searched for media tags. The media tags are associated with the media attribute and include media program data associated with the media attribute. The tagged media program file corresponds to a media program broadcast in a media services network. The media tags are automatically assembled to create tagged media program segments based on the media attribute. The tagged media program segments are linked, in sequential order, to create a customized tagged media program file based on the media attribute. Portions of the media programs corresponding to the customized tagged media program file are located and may be played back on a media player or saved as a new or custom media program. The custom media program including the located portions may then be played back by a media player as a single media program, or as individual elements.

According to another exemplary embodiment, tagged media program files are created from media program data by receiving one or more media tags defining a media attribute associated with the media program data. The media program data is associated with a broadcast media program in a media services network. The media tags are inserted into the media program data to create the tagged media program file.

According to still another exemplary embodiment, recommendations may be automatically generated for viewing media program content based on previously viewed media programs, which may include custom media programs created using tagged media program segments, stored on a media device for communicating broadcast media programming. A log is generated comprising details of the previously viewed media programs for one or more users of the media device. The log is scanned for broadcast information associated with each previously viewed media program to determine any missing media programs. If it is determined that there are missing media programs they are searched for and retrieved from one or more media program sources in communication with the media device. Once the missing media programs are retrieved from the one or more media program sources, a message is displayed containing a viewing recommendation with respect to the missing media programs. The message is displayed to each of the users of the media device.

These and various other features, as well as advantages, which characterize the various embodiments, will be apparent from a reading of the following detailed description and a review of the associated drawings. It is to be understood that both the foregoing general description and the following detailed description are explanatory only and are not restrictive of the invention as claimed.

### BRIEF DESCRIPTION OF THE DRAWINGS

FIG. 1 is a network diagram illustrating aspects of a media services network utilized in and provided by various embodiments;

FIG. 2 is a tagged media file utilized by the media player application in the network of FIG. 1 in accordance with various embodiments;

FIG. 3 is a flow diagram illustrating aspects of a process for linking and playing portions of media associated with linked segments of tagged media, in accordance with various embodiments; and

FIG. 4 is a timeline diagram illustrating the linking of media segments by the media player application in the network of FIG. 1, in accordance with various embodiments.

### DETAILED DESCRIPTION

As briefly described above, various embodiments are directed to presenting and linking segments of tagged media files in a media services network. In the following detailed description, references are made to the accompanying drawings that form a part hereof, and in which are shown by way of illustrations specific embodiments or examples. These embodiments may be combined, other embodiments may be utilized, and structural changes may be made without departing from the spirit or scope of the present invention. The following detailed description is therefore not to be taken in a limiting sense, and the scope of the present invention is defined by the appended claims and their equivalents.

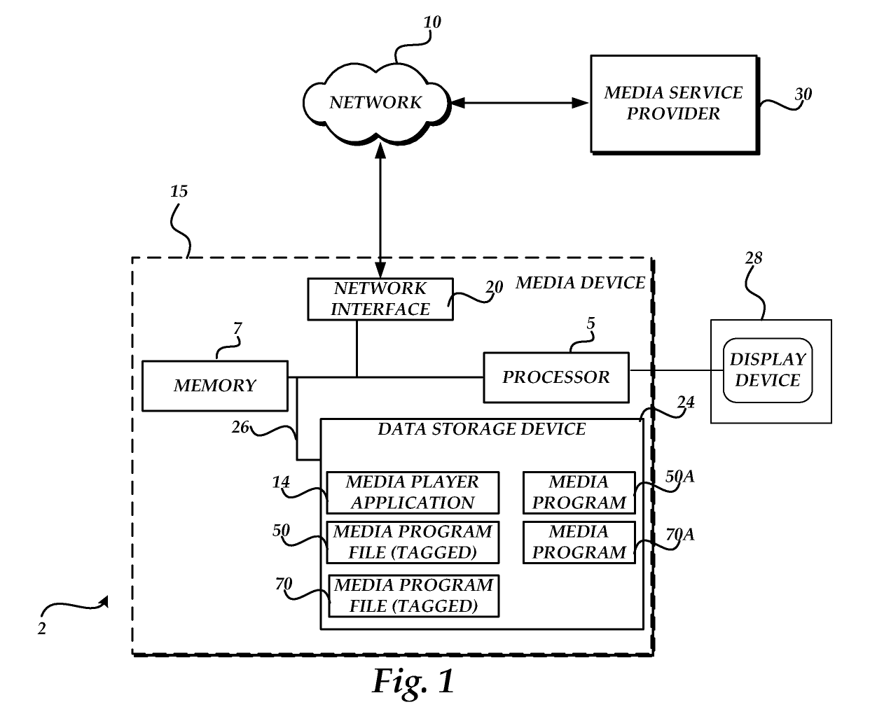

Various embodiments may be generally employed in a media services network 2 as shown in FIG. 1. The media services network 2 may include a data network 10 in communication with media service provider 30 and a media device 15 which may also be connected to a display device 28 for playing back media files. The media service provider 30 may provide media programming to the media device 15 over the network 10. In one exemplary embodiment, the media programming may be communicated to the media device 15 as a media stream which may include traditional digital and analog video programming, information content, and Internet data packets. According to embodiments of the present invention, the media programming may include, but is not limited to, regularly scheduled and on-demand television programs, advertisements, and Internet available media via streaming or download. It will thus be appreciated that the media service provider 30 may be a cable television (CATV) services provider, a satellite television services provider, an over-the-air network provider, an Internet access provider, and the like. It should be understood that in accordance with one exemplary embodiment, the media service provider 30 may also be capable of providing multiple services. For instance, the media service provider 30 may serve as both a CATV provider and an Internet access provider.

The network 10 communicates the media streams (i.e., media programming) and other data between the media service provider 30 and the media device 15. The network 10 may include any form of physical or wireless transport capable of delivering the media and control signaling required between the media device 15 and the service provider 30.

The media device 15 may be a multipurpose computing device which receives media programs (i.e., as media steams) from the media service provider 30 via the network 10 and which includes a processor 5, a memory 7, a network interface, a data storage device 24, and a bus 26 that couples the various device components including the memory 7 to the processor 5. It should be understood that the media device 15 may be implemented as any number of devices capable of receiving and playing back media programs including, but not limited to, general purpose desktop or laptop computers, media set-top boxes (including CATV and satellite), portable video players, cellular phones, VoIP phones, PDAs, and the like.

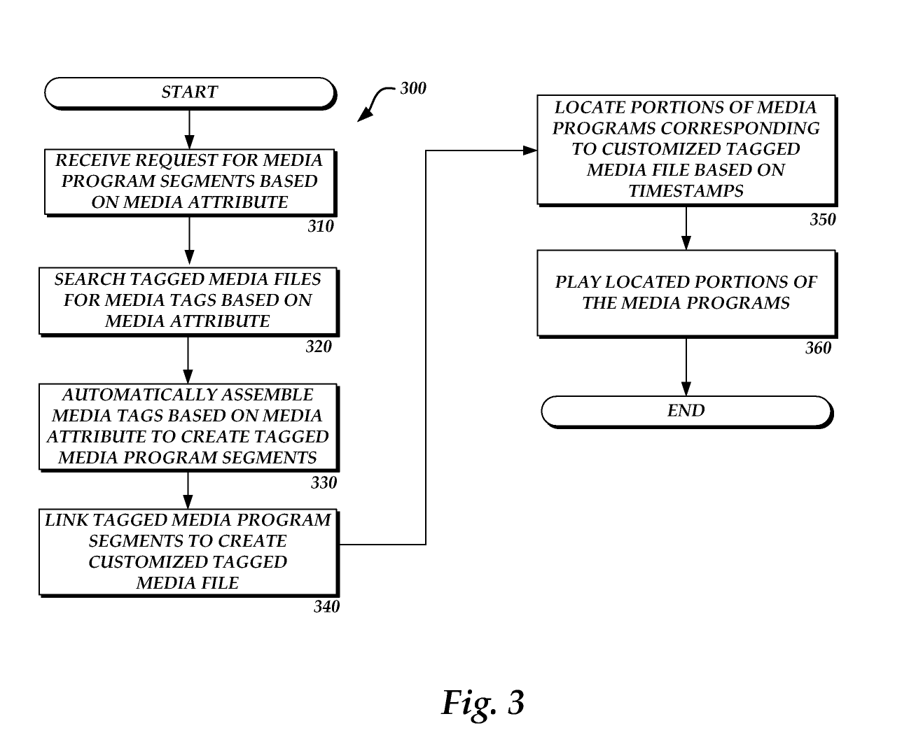

The memory 7 may include a read-only memory (ROM) and/or random access memory (RAM). The network interface 20 is an input/output mechanism which is capable of receiving media programs, such as media programs 50A and 70A, from the media service provider 30 via the network 10. The received media programs 50A and 70A may be stored on the data storage device 24 which provides storage for computer-readable instructions, data structures, program modules, and the like. In particular, the data storage device 24 stores a media player application 14 for obtaining and linking segments of tagged media program files, such as tagged media program files 50 and 70 (also stored on the data storage device 24), to create customized media programs for playback on the display device 28. The display device 28 is connected to the media device 15 and receives output video and audio signals associated with media programs. The display device 28 may be a television, a monitor, or the like, which is capable of receiving and displaying video and audio. The processor 5 may be programmed with instructions contained in the media player application 14 (and which may be executed in the memory 7) to perform processes for obtaining and linking segments of tagged media program files, as will be described in greater detail below with respect to FIG. 3.

As briefly mentioned above, the media program files 50 and 70 stored on the media device 15 may be “tagged.” As defined herein, tagged media programs are data (e.g., closed captioning data and script data) associated with media programs which have been parsed and inserted with media “tags” or markers to identify certain media attributes contained therein. The media attributes may include, but are not limited to, characters, topics, storylines, acts, and scenes. For instance, a character tag may be used to identify a group of characters or a specific character as well as spoken dialogue. Similarly, a storyline tag may be used to identify a portion of a media program pertaining to a particular storyline which may cover one or more episodes. It should be appreciated that a television series may include several programs or episodes which are broadcast over a season or multiple seasons. A particular episode may include characters who also appear in other episodes broadcast during a season but who do not appear in every episode. Similarly, a television series may discuss numerous topics or describe a number of storylines in one or more episodes during the course of a season or multiple seasons of the program. It will also be appreciated that characters and storylines in a television series may not appear in consecutive episodes or even in consecutive seasons of a television program.

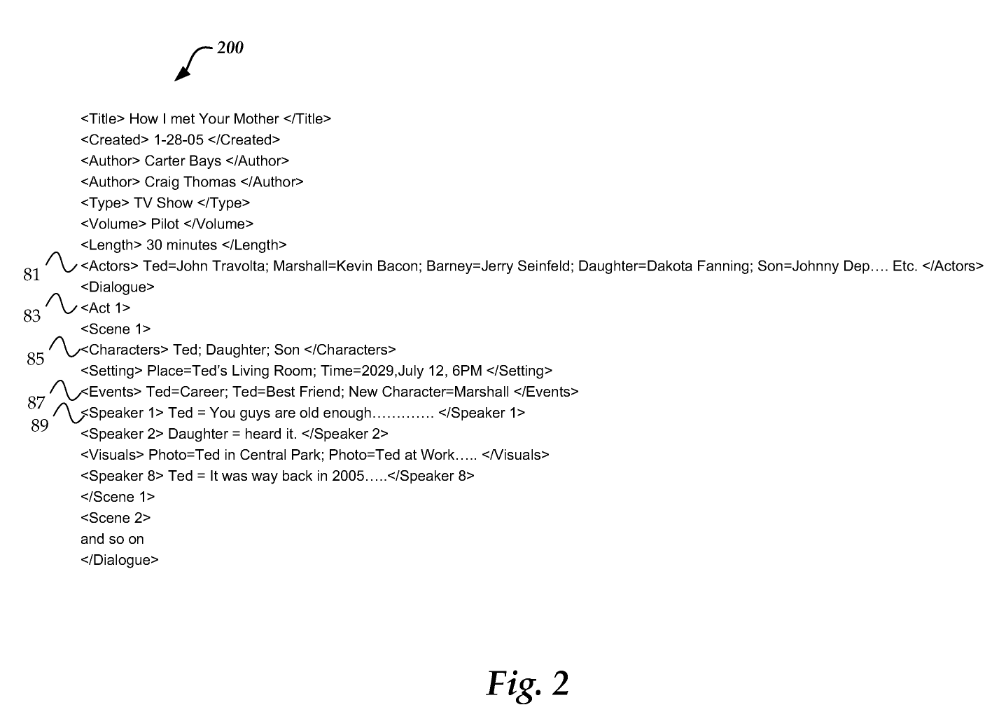

According to one exemplary embodiment, the media tags may be extensible markup language (XML) tags which are manually inserted into media program data by a video editor using a script and closed captioning data during the production process. In particular, the video editor may utilize an XML insertion program to insert the media tags while reviewing the final copy of the media program for production. In this manner the editor is able to align the tags with digital timestamps in the media program content. In the tagging process, the script would be used as a starting point to load tag definitions provided by the author so that the editor may then drag and drop the tags into the media program in sequence. For instance, using an XML insertion program, a video editor may load a list of common tags found in the script and use the script to insert the tags in closed captioning data associated with the media program to create a tagged media program file. It should be understood that during the creation process, the digital timestamps from the media program content are embedded into the tagged media program file by the video editor. As will be discussed in greater detail below with respect to FIG. 3, the media player application 14 may use the timestamps in tagged media program files to locate corresponding media program segments in actual media programs (i.e., programs containing video and audio content) and determine “link points” for linking media program segments from different media programs. It should be further understood that in accordance with exemplary embodiments, the tagged media program file may be appended to or embedded with a media program broadcast signal. An exemplary tagged media program file will be described in greater detail below with respect to FIG. 2.

In one exemplary embodiment, the media player application 14 may be configured to generate a log of previously viewed media programs. In particular, the log may be generated for a television program and provide details such as the number of the episode, season, the source of the program, and when and where the program was viewed (e.g., episode 12 in season 8 of “ER” was viewed on Apr. 7, 2006 at 8:46 PM on the family room television). It should be appreciated that a separate log may be generated for each user of the media device 15. For instance, the media player application 14 may generate a separate viewing log for individual members of a family. It should be understood that according to another exemplary embodiment the media player application 14 may also be configured to recognize missed episodes of a media or television program and then search for and retrieve the missed episodes. For instance, the media player application 14 may be configured to scan the viewing log and determine that one or more previous episodes of a television program has not been watched. The media player application 14 may further be configured to search for and retrieve the missed episodes from the data storage device 24, the media service provider 30, or a networked media server (not shown). Once the missed episodes have been retrieved, the media player application 14 may then display a message containing information about the missed episodes to one or more users of the media device 15. For instance, the media player application 14 may determine a user has missed a previous episode of “ER” and generate a message such as “You should watch episode 14 in season 7 before downloading/watching the next episode.”

Referring now to FIG. 2, an exemplary tagged media program file 200, utilized by the media player application 14, will now be described. The tagged media program file 200 includes XML tags for identifying media attributes (e.g., characters appearing in a broadcast television program) which may be found in a script and/or closed captioning data. For instance, the tagged media program file 200 includes an “Actors” tag 81 for identifying actors in the media program, a “Scene” tag 83 for identifying a scene in the media program, a “Characters” tag 85 for identifying characters, an “Events” tag 87 for identifying events occurring in the media program, and a “Speaker” tag 89 for identifying dialogue spoken by a character in the media program. It will be appreciated that one or more of the events identified in the Events tag 87 may be utilized as a storyline tag for identifying storylines in a media program. For instance, the event “Career” identified by the Events tag 87 may identify a storyline for the character Ted's career. Similarly, the “Speaker” tag 89 may be utilized as a character tag for individual characters in a media program. As discussed briefly above with respect to FIG. 1, the tagged media program file may also have embedded timestamps (not shown) which correspond to timestamps in an associated media program. For instance, “Scene 1” (identified by the Scene tag 83) in the tagged media program file 200 may have a timestamp of five minutes which corresponds to the starting point of the first scene as measured from the beginning of the media program broadcast.

It should be understood that the media tags 81-89 described above are not exhaustive and that other tags may also be utilized to identify characters and storylines. Furthermore, additional tags may be defined to identify other portions of a media program, including but not limited to, topics, the current season of the media program, and volumes (i.e., episodes). It should also be understood that in other exemplary embodiments, tags may be inserted which contain URLs for linking with websites providing additional information or features associated with a media program. For instance, a media program may include a “Trivia” tag to access a website which offers trivia questions regarding an episode of the media program or a “Clues” tag to access a website in which a user may find clues with respect to a mystery storyline shown in the media program.

Referring now to FIG. 3, an illustrative routine 300 will be described illustrating a process performed by the performed by the media player application 14 executing on the media device 15 for obtaining and linking segments of tagged media to create customized media programs for playback. When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated in FIG. 3, and making up the embodiments described herein are referred to variously as operations, structural devices, acts or modules. It will be recognized by one skilled in the art that these operations, structural devices, acts and modules may be implemented in software, in firmware, in special purpose digital logic, and any combination thereof without deviating from the spirit and scope of the present invention as recited within the claims set forth herein.

The routine 300 begins at operation 310, where the media device 15 receives a request for media program segments from based on a specified media attribute. For instance, the request may be a query for all instances or scenes in one or more television series in which a specified character appears. It should be understood that the query may cover current and past media programming associated with one or more series in which a particular character or storyline appears. It should also be understood that a media program, such as an episode of a television series, may be associated with one or more additional series, such as one or more other television series, movies, and/or advertisements. Thus, characters and storylines appearing in one episode of a television series may also appear in one or more episodes of another television series (these are known as crossover episodes). Accordingly, the request in exemplary embodiments may include characters, storylines, etc. which appear in more than one media program and in more than one television series. In one exemplary embodiment, the request for the media program segments may be made via a user interface (not shown) generated by the media player application 14. For instance, using the interface, a user may input a query to instruct the media player application 14 to search for specific media programs; select a media tag (or media attribute) within a tagged media program file to search for media segments; save, view, edit, or delete resulting media segments found in the search; and save the final result. It should be understood that a media program segment represents at least a portion of a media program. For instance, a media program segment may be the first fifteen minutes of a sixty minute television program. As discussed above in the discussion of FIG. 1, media attributes may include, but are not limited to, characters, topics, storylines, acts, and scenes.

From operation 310, the routine 300 continues to operation 320, where the media application program 14 searches tagged media program files corresponding to available media programs for media tags based on the media attribute. For instance, in one exemplary embodiment, in response to the request made in operation 310, the media player application 14 may search all of the tagged media program files stored on the data storage device 24 of the media device 15 for a specific character tag identifying a character in a television program. In another exemplary embodiment, the request of operation 310 may also include the name of a media program, such as the name of a television series, and the media player application 14 will only search tagged media program files corresponding to the specified series in response to receiving the request. It should be understood that if a particular tagged media program file does not contain the specified media attribute, the media player application 14 may continue searching additional tagged media program files until a match is found. It will be appreciated that the tagged media program files stored on the data storage device 24 may be downloaded from the media service provider 30 or from a networked media server (not shown) for storing media programs and associated tagged media program files, over the network 10.

From operation 320, the routine 300 continues to operation 330, where the media player application 14 automatically assembles the media tags in the tagged media program files which were found to be based on the specified media attribute at operation 320, to create tagged media program segments. In particular, the media player application 14 may extract the portions of the tagged media program files defined by XML tags (e.g., a specified character's dialogue) related to the specified media attribute. The extracted portions of the tagged media program files are then assembled into new tagged media files or tagged media program segments. It should be understood that each newly created tagged media program segment may only include tags related to the specified media attribute and extracted from a tagged media program file.

From operation 330, the routine continues to operation 340, where the media player application 14 links all of the tagged media program segments associated with the specified media attribute, in sequential order, to create a single customized tagged media program file. In a further embodiment, the tagged media program segments associated with the specified media attribute may be linked in random order or in a customized order based on input from a user of the media device. In particular, the customized tagged media program file may be an XML markup file describing a character's appearances in one more seasons of a television series. For instance, if the media attribute identifies a specific character in the television series “ER”, all of that character's appearances (i.e., scenes and dialog) will appear in the newly created customized tagged media program file, in sequential order. In one exemplary embodiment, the customized tagged media program file may be an XML markup file describing a character's appearances in two or more different television programs or series. For instance, the media player application 14 may link media program segments associated with a character appearing in both the television series “Lost” and the television series “ER”. Thus, it will be appreciated that the customized tagged media program file may also include scenes from multiple television series in which a character or storyline appears (i.e., crossover episodes).

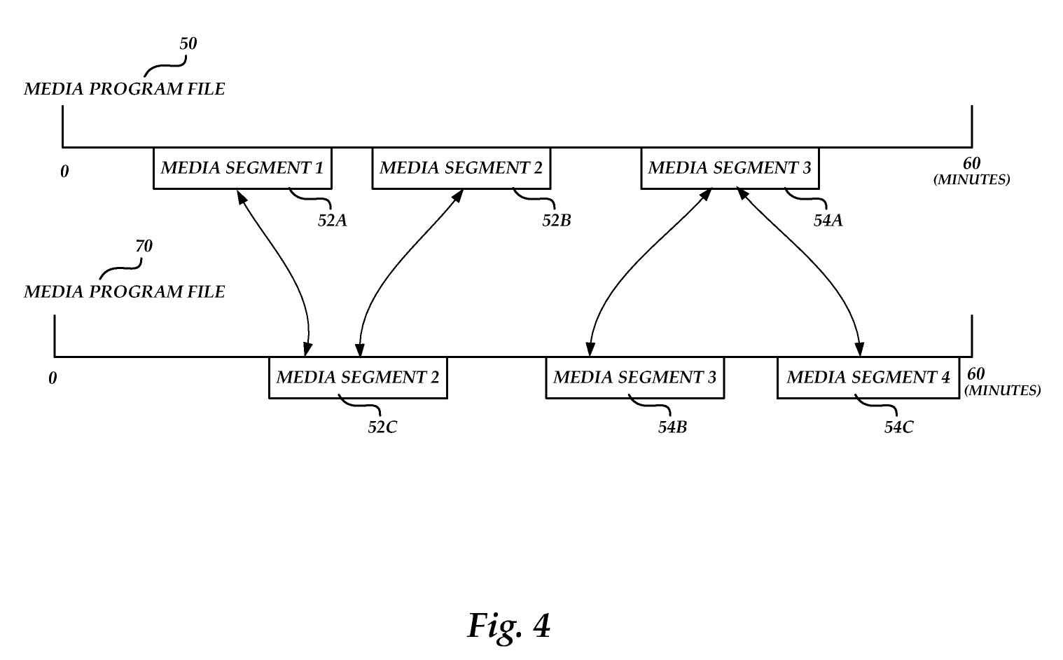

It should be understood that the linked media program segments may include non-contiguous segments from multiple media programs. For instance, a customized tagged media program file may include a segment representing a storyline appearing in the first fifteen minutes of the second episode in season one of “ER” while the next segment (i.e., the continuation of the storyline) may be from the last fifteen minutes of the fourth episode in season two of the same television series. An exemplary timeline diagram showing the linking of tagged media program segments is described below with respect to FIG. 4.

From operation 340, the routine 300 continues to operation 350, where the media player application 14 locates portions of the media programs corresponding to the customized tagged media program file created at operation 340 based on timestamp information. In particular, the media player application 14 may match the timestamps for each of the tagged media program segments making up the customized tagged media program file with timestamps in corresponding media programs (i.e., media programs containing video and audio content) to locate media for playback and for creating a customized video program based on the media attribute received in the request at operation 310.

From operation 350, the routine 300 continues to operation 360, where the media player application 14 plays the located portions of the media programs. In particular, the media player application 14 may be configured to sequentially play portions of media programs corresponding to the media segments identified in the customized tagged media program file created at operation 350. In one exemplary embodiment, the media player application 14 may be configured to use the customized tagged media program file to retrieve the specified portions from multiple media programs stored on the data storage device 24 (e.g., the media programs 50A and 70A) and play the specified portions in sequential order through a viewer. In another exemplary embodiment, the media player application 14 may be configured to save the located portions of the media programs as a special or customized media file which a user may then playback as a stored media program. It will be appreciated that in this manner, customized video clips based on a specified media attribute (e.g., a character or storyline) may be retrieved and viewed as a new media program file or “on the fly” (i.e., without creating a file comprising the new media program file). The routine 300 then ends.

FIG. 4 is a timeline diagram illustrating the linking of media program segments by the media player application 14. The timeline diagram shows the tagged media program 50 as a sixty minute media program which includes media segment 52A, media segment 52B and media segment 54A. The timeline diagram also shows the tagged media program 70 as a sixty minute media program which includes media segment 52C, media segment 54B, and media segment 54C. It should be understood that media segments 52A, 52B, and 52C are related media segments in that they share a common media attribute (e.g., a storyline) and that media segments 54A, 54B, and 54C are related media segments in that they also share a common media attribute. For instance, the media segments 52A, 52B, and 52C may be portions of the tagged media programs 50 and 70 representing a storyline in a television series. Similarly, the media segments 54A, 54B, and 54C may be portions of the tagged media programs 50 and 70 representing a different storyline in the television series. As discussed above with respect to FIG. 3, the media player application 14 may link related segments which have media tags associated with a specified media attribute to create a single customized tagged media program file. Thus, the media segments 52A and 52B from the tagged media program 50 may be linked with the media segment 52C from the tagged media program 70 to create the customized tagged media program file. Similarly, the media segment 54A from the tagged media program 50 may be linked with the media segments 54B and 54C from the tagged media program 70 to create another customized tagged media program file.

Based on the foregoing, it should be appreciated that various embodiments are directed to presenting and linking segments of tagged media files in a media services network. It will be apparent by those skilled in the art that various modifications or variations may be made in the present invention without departing from the scope or spirit of the invention. Other embodiments will be apparent to those skilled in the art from consideration of the specification and practice of the invention disclosed herein.

I claim:

1. A method for presenting segments of tagged media in a media services network, comprising:
receiving a request for at least one media program segment based on a media attribute appearing in one or more media programs;
searching at least one tagged media program file for a plurality of media tags, wherein the plurality of media tags are associated with the media attribute and comprises media program data associated with the media attribute, wherein the at least one tagged media program file corresponds to the at least one media program;
assembling the plurality of media tags from the at least one tagged media program file to create tagged media program segments based on the media attribute;
linking the tagged media program segments to create a customized tagged media program file based on the media attribute;
locating portions of the one or more media programs corresponding to the customized tagged media program file; and
playing the located portions of the one or more media programs on a media player.

2. The method of claim 1, wherein locating the portions of the one or more media programs corresponding to the customized media program file comprises locating non-contiguous portions of the one or more media programs based on timestamp information.

3. The method of claim 1, wherein receiving a request for at least one media program segment based on a media attribute appearing in one or more media programs comprises receiving a query for at least one of characters, storylines, topics, acts, and scenes appearing in the one or more media programs.

4. The method of claim 1, wherein searching at least one tagged media program file for a plurality of media tags comprises searching an XML markup file for tags identifying the media attribute.

5. The method of claim 1, wherein searching at least one tagged media program file for a plurality of media tags comprises searching closed captioning data for tags identifying the media attribute.

6. The method of claim 1, wherein searching the at least one tagged media program file for a plurality of media tags comprises searching the at least one tagged media program file for at least one storyline tag, the at least one storyline tag comprising data associated with a storyline appearing in the at least one media program.

7. The method of claim 1, wherein searching the at least one tagged media program file for a plurality of media tags comprises searching the at least one tagged media program file for at least one character tag, the at least one character tag comprising data associated with a character appearing in the at least one media program.

8. The method of claim 1 further comprising saving the located portions of the one or more media programs as a new media program.

9. A method of creating a tagged media program file from media program data in a media services network, comprising:
receiving at least one media tag defining a media attribute associated with the media program data, wherein the media program data is associated with a broadcast media program in the media services network; and
inserting the at least one media tag into the media program data to create the tagged media program file.

10. The method of claim 9, wherein receiving at least one media tag defining a media attribute associated with the media program data comprises receiving at least one markup language, the at least one markup language tag defining at least one of the following attributes appearing in the broadcast media program: character, storyline, topic, act, and scene.

11. The method of claim 9, wherein inserting the at least one media tag into the media program data to create the tagged media program file comprises inserting the at least one media tag into script data associated with the broadcast media program.

12. The method of claim 9, wherein inserting the at least one media tag into the media program data to create the tagged media program file comprises inserting the at least one media tag into closed captioning data associated with the broadcast media program.

13. The method of claim 9, further comprising inserting timestamps from the broadcast media program into the tagged media program file.

14. The method of claim 9 further comprising appending the tagged media program file to a media program broadcast signal.

15. The method of claim 9 further comprising embedding the tagged media program file with a media program broadcast signal.

16. A method for recommending media program content based on previously viewed media programs stored on a media device for communicating broadcast media programming, comprising:
generating a log comprising details of the previously viewed media programs for at least one user of the media device;
scanning the log for broadcast information associated with each of the previously viewed media programs to determine at least one missing media program;
if it is determined that there is at least one missing media program, then searching for the at least one media program in one or more media program sources in communication with the media device;
retrieving the at least one missing media program from the one or more media program sources; and
displaying a message containing a viewing recommendation with respect to the at least one missing media program to the at least one user of the media device.

17. The method of claim 16, wherein generating a log comprising details of the previously viewed media programs for at least one user of the media device comprises generating a log including at least one of an episode, season, program name, and program source associated with each of the previously viewed media programs.

18. The method of claim 16, wherein searching for the at least one media program in one or more media program sources in communication with the media device comprises searching for the at least one media program in at least one of a data storage device, a media service provider, and a networked media server in communication with the media device and wherein the at least one media program comprises a custom media program created using tagged media program segments.

19. The method of claim 16, wherein displaying a message containing a viewing recommendation with respect to the at least one missing media program to the at least one user of the media device comprises displaying a message recommending the viewing of the at least one media program prior to viewing a related media program.

20. The method of claim 16, wherein generating a log comprising details of the previously viewed media programs for at least one user of the media device comprises generating a separate log comprising details of previously viewed media programs associated with each of a plurality of users of the media device.
